(19) United States
(12) Patent Application Publication
(10) Pub. No.: US 2011/0133957 A1
(43) Pub. Date: Jun. 9, 2011

(54) VEHICLE PARKING LOCATOR SYSTEM AND METHOD USING CONNECTED VEHICLES

(75) Inventors: ANDREW P. HARBACH, KOKOMO, IN (US); FREDERICK F. KUHLMAN, KOKOMO, IN (US); DWADASHI H.R. SARMA, KOKOMO, IN (US)

(73) Assignee: DELPHI TECHNOLOGIES, INC., TROY, MI (US)

(21) Appl. No.: 12/629,953

(22) Filed: Dec. 3, 2009

(51) Int. Cl. G08G 1/14; B60Q 1/48

(52) U.S. Cl. 340/932.2

(57) ABSTRACT

A vehicle parking locator system and method are provided. The system includes a database storing data pertaining to the vehicle parking locations including available parking locations, and a communication link for communicating with vehicles and other sources. The communication link receives parking location information including information pertaining to availability of parking locations and further provides vehicles with parking location information to assist in locating a parking location. The system further includes a processor for processing the stored data in the database and providing parking location information to vehicles.

### TECHNICAL FIELD

The present invention generally relates to vehicle parking assist, and more particularly relates to a system and method for managing and locating available parking locations for one or more vehicles.

### BACKGROUND OF THE INVENTION

Drivers of automotive vehicles in urban settings frequently waste a lot of time driving around a parking lot in search of an open or optimal parking lot location also referred to as a parking spot. The search for a parking spot can be exasperated when multiple vehicles which are driving in a caravan or together are looking for nearby parking locations. To alleviate locating a parking spot, some parking lot facilities have provided an indication in a parking garage that there are parking spaces available. However, the designated parking locations are typically not provided to the vehicle driver. Additionally, some parking lot facilities have proposed installing sensors in the parking spots which may allow opening parking spot information to be shared on the Internet. Satellite radio (e.g., XM Radio®) may also provide information on how full a parking garage is.

Despite the attempts to enhance the parking space locating process, the proposed solutions have several weaknesses. For example, the conventional systems typically depend on the owner or operator of the parking facility to collect the parking lot data and report the data. Additionally, some of the systems require expensive infrastructure changes to install sensors and communication devices, which costs are typically passed on to the users via user fees. The conventional systems typically do not provide assistance in locating the optimal parking spot nor adequately help with multiple vehicle driving scenarios.

### SUMMARY OF THE INVENTION

According to one aspect of the present invention, a vehicle parking locator system is provided. The system includes a database storing data pertaining to vehicle parking locations including available parking locations. The system also includes a communication link for communicating with one or more vehicles. The communication link receives parking location information including information pertaining to the availability of parking locations, and further provides the one or more vehicles with parking location information to assist in locating a parking location. The system further comprises a processor for processing the stored data in the database and providing parking location information to one or more vehicles.

According to another aspect of the present invention, a method for managing vehicle parking locations and providing parking location information to one or more vehicles is provided. The method includes the steps of storing data in a database pertaining to vehicle parking locations including available parking locations, and receiving parking location information including information pertaining to availability of parking locations. The method further processes the stored data with a processor and communicates with one or more vehicles to provide the one or more vehicles with parking location information to assist in locating a parking location.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a schematic block diagram illustrating a vehicle parking locator system interacting with vehicles and other parking location data sources, according to one embodiment;

FIG. 2 is a schematic view of a vehicle communicating with the parking locator system shown in FIG. 1;

FIG. 3 is a block diagram illustrating the vehicle parking locator system, according to one embodiment;

FIG. 4 is a block diagram illustrating a vehicle and various features utilized in connection with the parking locator system, according to one embodiment;

FIGS. 5A-5C are top views of a parking lot showing a vehicle entering a parking spot in FIG. 5A, parked in the parking spot in FIG. 5B and exiting the parking spot in FIG. 5C, according to one example;

FIGS. 6A-6C are top views of a parking lot illustrating a vehicle entering a parking spot in FIG. 6A, parked in the parking spot in FIG. 6B, and exiting the parking spot in FIG. 6C, according to another example;

FIG. 7 is a flow diagram illustrating a routine for managing and providing parking spot locations, according to one embodiment; and

FIG. 8 is a flow diagram illustrating a routine for predicting parking spot availability, according to one embodiment.

### DESCRIPTION OF THE PREFERRED EMBODIMENTS

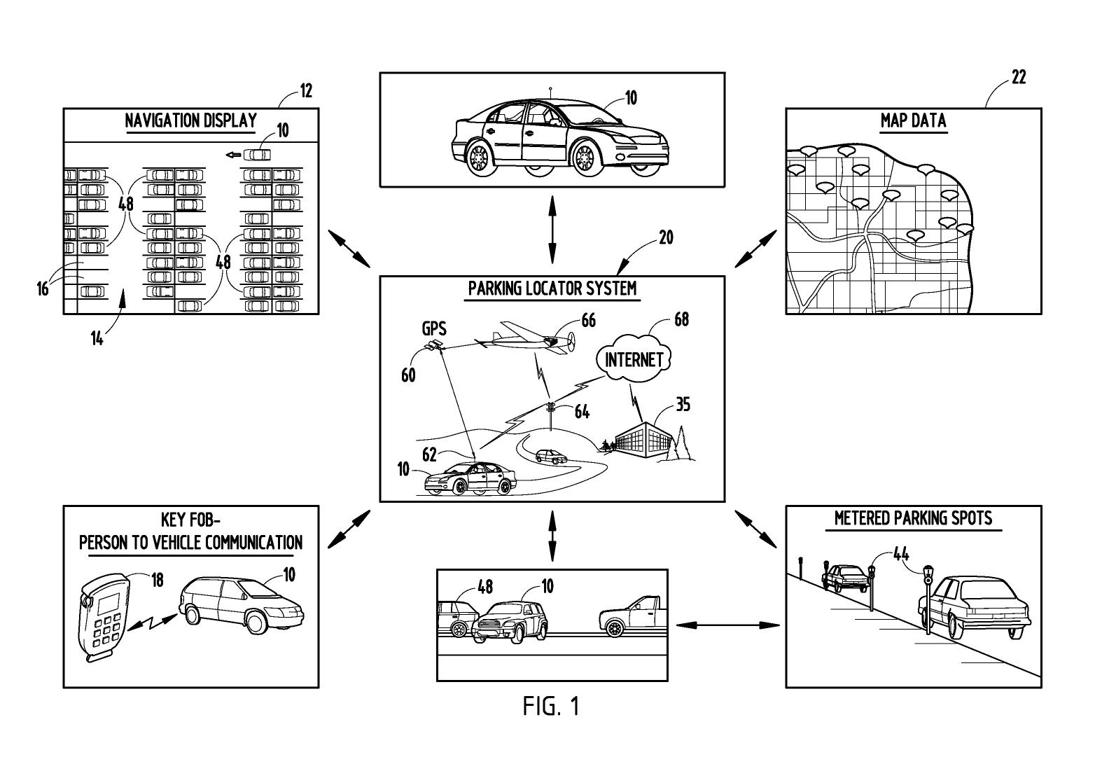

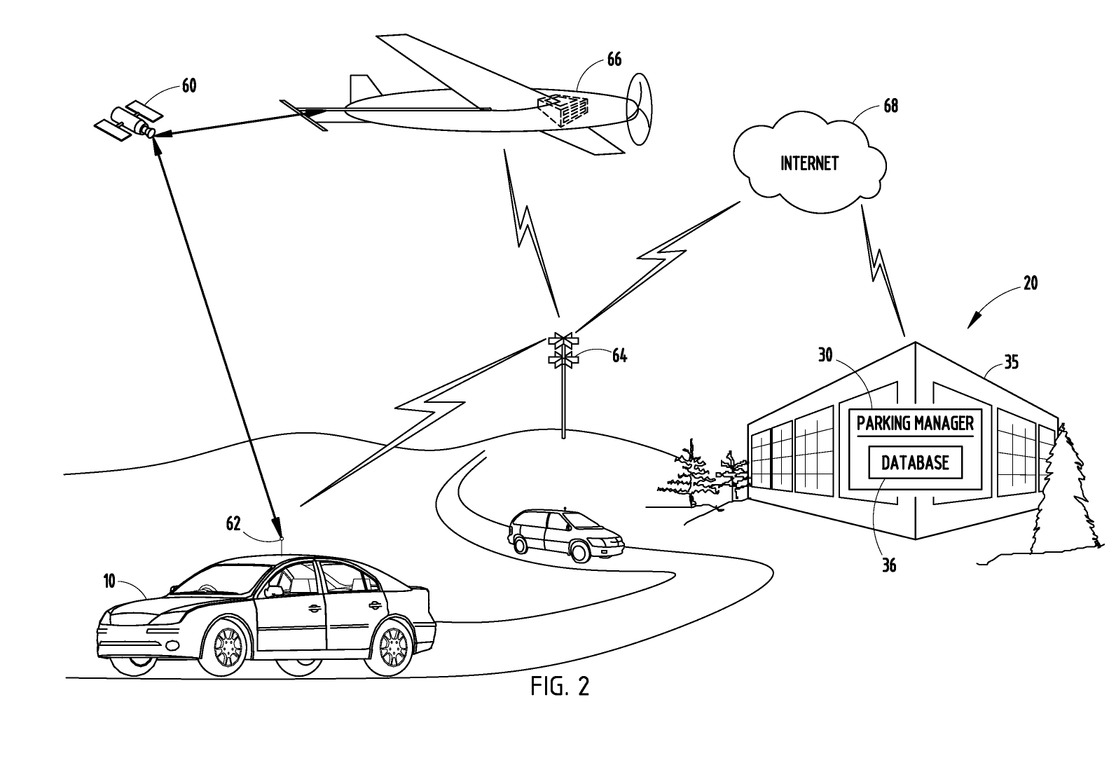

Referring now to FIGS. 1 and 2, a real time vehicle parking locator system 20 is generally illustrated in communication with a plurality of vehicles and devices for assisting vehicles with parking spot locations. The vehicle parking locator system 20 includes a database located at a location remote from the vehicles, such as a service facility 36, according to one embodiment. The database stores data pertaining to vehicle parking locations including available parking locations. The parking locator system 20 includes one or more communication links for communicating with the plurality of vehicles 10 and other devices as described herein. The communication link receives from various connected sources parking location information including information pertaining to the availability of one or more parking locations. The communication link further provides one or more vehicles with parking location information to assist one or more vehicles in locating a parking location. The system 20 further includes a processor for processing the stored data in the database and generating parking location information relevant to the one or more vehicles 10.

The vehicle parking locator system 20 is shown in FIG. 2 having a service center 35 in signal communication with one or more connected vehicles 10, such as via a communication link that may include the internet 68. The service center or facility 35 contains the parking locator system 20 including a parking manager 30 and a real time database 36. The internet access for the vehicles 10 may be achieved by way of wireless communication using a cellular service provider, OnStar®, a mesh network or other peer-to-peer wireless network, or other available wireless communication link. In the embodiment shown, one or more antennas 62 are provided on a vehicle 10 to communicate with terrestrial antennas 64. Alternately or in combination, the communication link may communicate wireless signals with vehicles 10 via satellites 60 and other devices, such as a repeater on aircraft 66 having communication reception and transmission capability. Each vehicle 10 is equipped with various sensors and devices that generate signals that may be communicated to the database 36 at facility 35 by way of the communication link to provide real time information relating to the position of the vehicle 10, positions of other vehicles 48 and parking lot information. Additionally, other connected sensors and devices located remote from the vehicle 10 may also communicate parking related information to the database. The information communicated to the database 36 may be stored in memory in the database and processed as described herein to provide useful parking lot information for use by one or more vehicles 10. The information stored in memory may be updated continually such that it is essentially real time data.

As seen in FIG. 1, the vehicle parking lot locator system 20 communicates with vehicles 10. Each of vehicles 10 may employ a navigation display or other display monitor for displaying map and parking lot location information. The display 12 may show a parking lot 14 as shown that includes parking spots 16 that are available for parking relative to occupied parking spots and other vehicles 48. Map data 22 may be provided via various sources and used by the vehicle parking locator system 20 or pre-installed within each vehicle 10. The map data 22 may include data pertaining to parking lot locations and roadways as should be evident to those skilled in the art.

The vehicle parking locator system 20 is shown communicating with a key fob 18 that may remotely control various features of a vehicle 10, such as trunk and door unlock functions. The key fob 18 is a person-to-vehicle communication device operated by a person to control vehicle functions and may further be useful to provide information about the vehicle 10 and the predicted use of the vehicle 10, such as an operator is expected to operate the vehicle 10 and depart from a parking location shortly after unlocking the doors. Additionally, remote sources, such as parking meters 44 are shown at metered parking locations that are allocated for vehicles to park in. The parking meters 44 may be smart sensors that have sensors that sense whether a vehicle is present in the corresponding parking spot. The parking meters 44 may be connected via signal communication to provide a signal indicative of a vehicle occupying the parking location or not based on the expiration of time of the meter, according to one embodiment. According to another embodiment, metered parking spots may be sensed by sensor(s) such as camera(s) located on one or more vehicles that are traveling by to determine parking spot vacancies. For street side parking spots, the street side may be treated as a one-dimensional parking lot. The parking meter information whether it is sensed vehicle information or based on the time expiration of the meter, may be provided to the database via signal communication for use in the vehicle parking locator system 20 as a further connected source for vehicle parking location information.

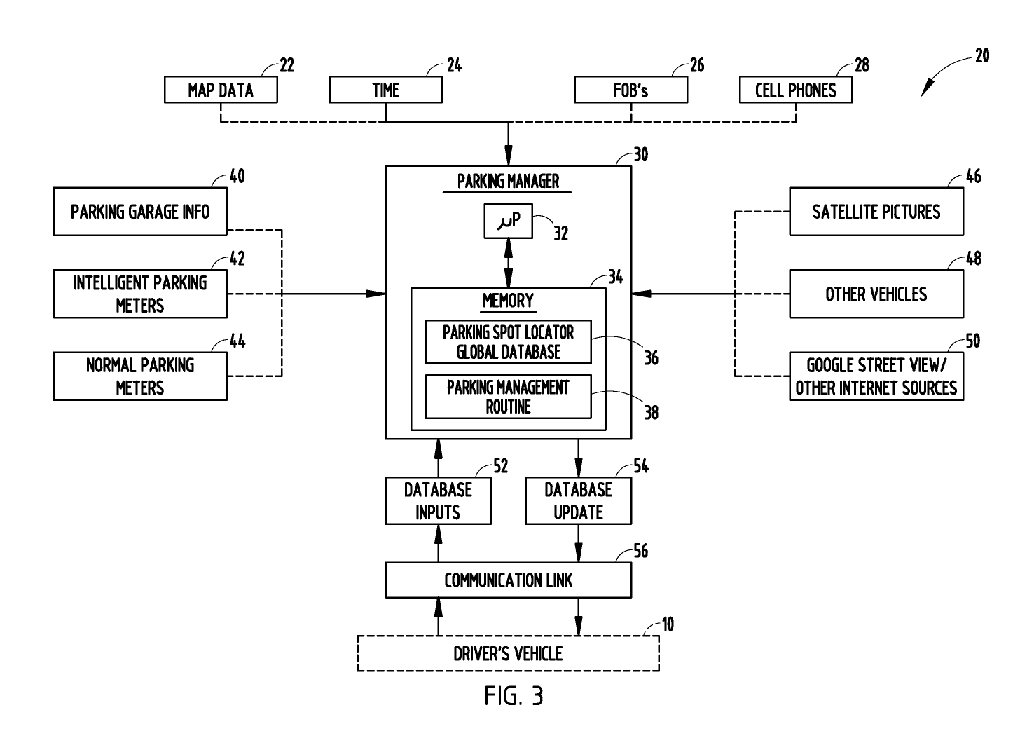

The vehicle parking locator system 20 is illustrated in further detail in FIG. 3 having a parking manager 30 configured to receive various input data and provide processed outputs. The parking manager 30 includes a processor such as a microprocessor 32 or other analog and/or digital processing circuitry. The parking manager 30 also includes memory 34, such as random access memory (RAM), read-only memory (ROM), electronically-erasable programmable read-only memory (EEPROM), flash memory, and other memory devices. Stored within memory 34 and processed by microprocessor 32 is the parking spot locator global database 36 for storing vehicle parking location information collected from various connected vehicles and other sources and made available for use in providing parking location information to one or more vehicles. Additionally, one or more parking management routines 38 are also stored in memory and executable by microprocessor 32.

The parking manager 30 is shown having a communication link 56 that enables the manager 30 to communicate with various connected vehicles and other connected sources of information. The communication link 56 may include an internet connection 68 that may be achieved by use of wireless cellular phones and landlines, according to one embodiment. The communication link 56 may include other wireless and satellite signal communications, such as OnStar®. The communication link 56 is in communication with various vehicles including one or more vehicles that provide data to the database 36 and receive parking lot information from the database 36. Parking manager 30 may provide database updates 54 via the communication link 56 to a driver's vehicle 10, such that the driver of the vehicle 10 may use the information to find a desired vehicle parking location. Additionally, vehicles 10 may report database inputs 52 via the communication link 56 to the parking manager 30, such as the location of the vehicle and available parking locations relative to other vehicles.

The parking manager 30 also receives map data 22, time information 24, key fob information 26, and cell phone information 28 from various inputs. Additionally, the parking manager 30 receives other sources of information, such as parking garage information 40 which may include information relayed from a parking garage facility indicative of the parking garage map, and vacancy of parking lots as reported by the parking garage facility via the internet or other communication link. Intelligent or smart parking meters 42 having sensors for sensing the presence of a vehicle may report via the internet or other communication link vehicle parking information to the parking manager 30. Additionally, parking meters without sensor(s) 44 may report parking lot information to the parking manager 30 such as whether the meter has timed out, thus inferring that the parking spot may be vacant. The parking manager 30 may further receive satellite generated pictures or photos (e.g., Google® Earth) 46 which may include further information regarding availability of parking locations. The parking manager 30 is shown communicating with other vehicles 48 which may include information such as position of the vehicles and sensed data which may be useful in determining whether certain parking locations are available. Further, the parking manager 30 is shown receiving Google® street view/other internet sources information 50 may provide additional information that may be helpful in determining parking lot location information.

It should be appreciated that the vehicle parking locator system 20 is located at a designated service location, such as a service provider, remote from the vehicles, according to one embodiment. The vehicle parking locator system 20 may be integrated with other service providers, such as OnStar®, XM/Sirius Radio®, and other service providers that communicate with vehicles to provide an integrated system for parking assist. It should further be appreciated that some or all of the vehicle parking locator system 20 may be otherwise integrated into one or more vehicles, such that the memory and processing of vehicles may be employed as part or all of the parking locator system 20, according to other embodiments.

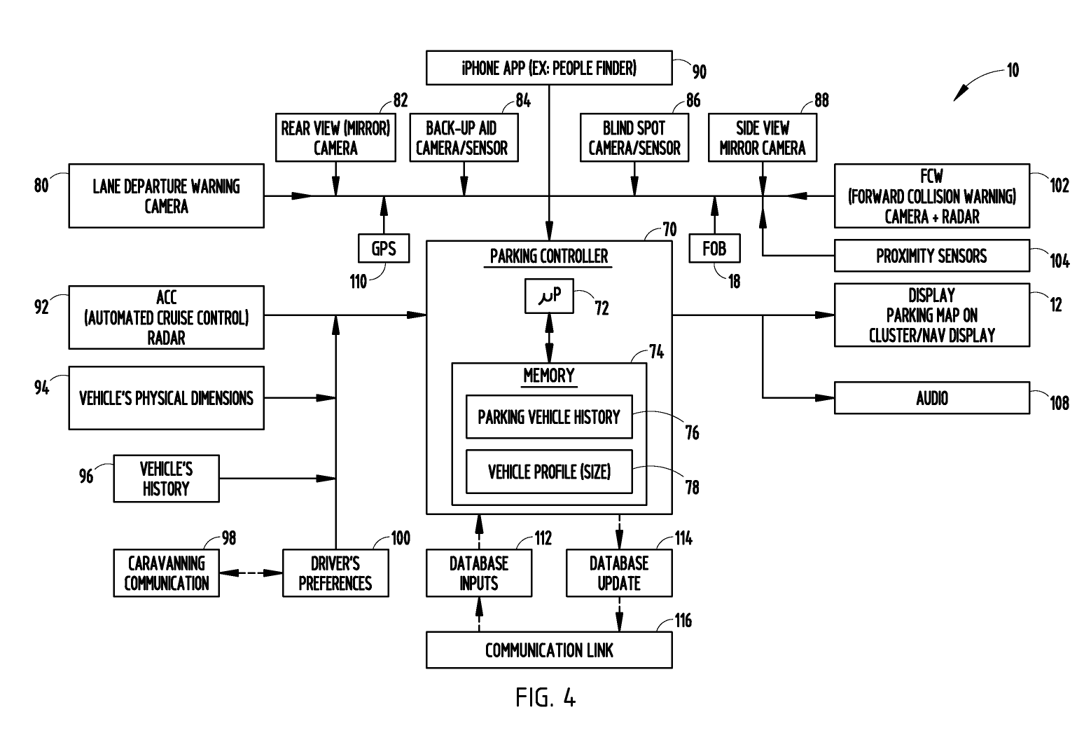

A vehicle 10 configured to communicate with the parking locator system 20 is illustrated in the block diagram in FIG. 4. Vehicle 10 is illustrated having a parking controller 70 shown having various inputs and outputs and communicating database updates 114 and database inputs 112 with the parking locator system via a communication link 116. The communication link 116 may include cellular phone, internet connection, satellite communication or other communications or a combination of communication services. The parking controller 70 is shown having a microprocessor 72 and memory 74. Microprocessor 72 may include any digital and/or analog circuitry for controlling the processing of various inputs and providing outputs. Memory 74 may include random access memory (RAM), read-only memory (ROM), electronically-erasable programmable read-only memory (EEPROM), flash memory, and other known memory devices. Stored within memory 74 are parking vehicle history data 76 and vehicle profile data 78, which may be processed by the microprocessor 72. The vehicle parking history data 76 may track historical data that is indicative of what a vehicle is predicted to do based on its history such as when and where the vehicle typically parks. The vehicle profile data 78 may include length and width data of the vehicle and any other profile information that may aid in finding a suitable parking spot for the vehicle. It should be appreciated that the parking controller 70 may be a dedicated controller dedicated to managing vehicle parking information, according to one embodiment. According to another embodiment, the parking controller 70 may be integrated with other vehicle control circuitry, according to other embodiments.

The vehicle 10 is shown having various sensors for sensing one or more conditions of the vehicle 10 and its surrounding area. The various inputs include proximity sensors including a lane departure warning camera 80, a rearview camera 82, a backup aid camera/sensor 84, a blind spot camera/sensor 86, a side view mirror camera 88, a forward collision warning (FCW) camera and radar 102, an automatic cruise control (ACC) radar 92, and various other proximity sensors 104. The various sensor inputs are provided to the parking controller 70 which may process the inputs and/or send the inputs to the vehicle parking locator system 20. The sensor inputs provide information regarding the area proximate to the vehicle 10 such as whether a parking location exists proximate to the vehicle 10 and whether another vehicle is parked in the parking location or it is unoccupied. The parking controller 70 also receives global positioning system (GPS) signals from a GPS receiver 110 indicating the position of the vehicle 10 and fob signals from the vehicle key fob 18. The GPS signals acquires position data which may be transmitted to the parking location system 20. Parking controller 70 may further receive signals from other devices, such as a phone as shown by an iPhone® application 90. The parking controller 70 may include further inputs such as the vehicle's physical dimensions (e.g., width and length) 94, the vehicle's history 96, caravanning communication information 98, and driver's preferences 100. It should be appreciated that the various aforementioned sensors and devices may be installed onboard the vehicle for other vehicle applications such that the parking locator system 20 does not require added sensors and devices to be implemented on a given vehicle.

The vehicle 10 is further shown having a display 12 that may display a parking map on a cluster/navigation display, according to one embodiment. The display 12 may otherwise be displayed elsewhere on the vehicle, such as on a rearview mirror or on other displays integrated within the vehicle 10 or in communication therewith. The vehicle 10 further includes an audio output 108. It should be appreciated that the parking controller 70 may output signals to the display 12 and audio 108 to direct the driver of the vehicle 10 to one or more available parking spot locations as determined by the vehicle parking locator system 20.

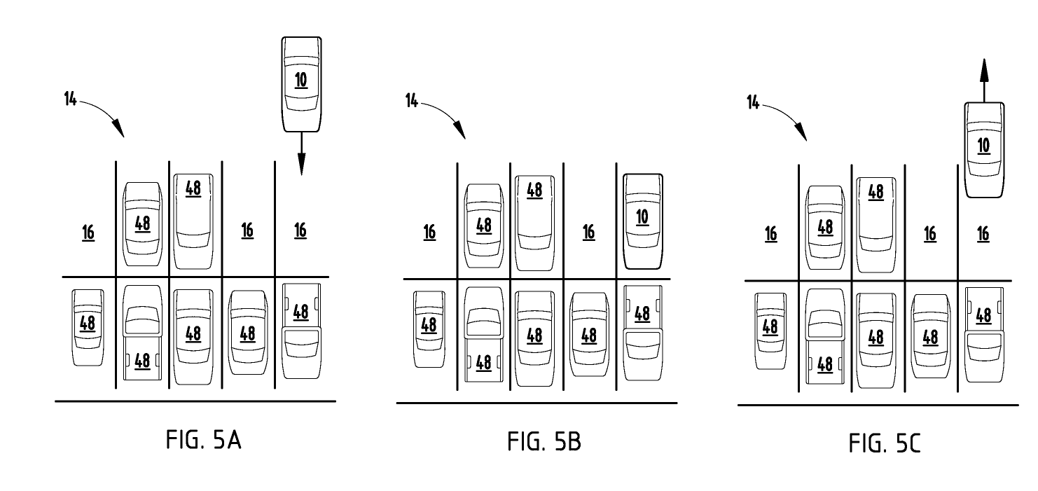

Referring to FIGS. 5A-5C, a vehicle 10 is shown approaching an available parking location 16 in a parking lot 14 using the vehicle parking locator system 20. The parking lot 14 is shown having a plurality of other vehicles 48 in certain parking locations 16, and having certain unoccupied parking locations 16. It should be appreciated that the vehicle parking locator system 20 may provide a map for display showing the availability of the available parking location 16 to assist in directing the vehicle 10 into a suitable parking location at the driver's discretion. In FIG. 5B, the vehicle 10 is shown parked within one of the available parking locations 16. In this position, the GPS position of the vehicle 10 may be reported to the vehicle parking locator system 20 such that the system 20 recognizes that the vehicle 10 is consuming a certain space of one of the parking locations 16 in the parking lot 14. In FIG. 5C, the vehicle 10 is shown departing from the parking location 16. The vehicle 10 may report its position via GPS signals to the vehicle parking locator system 20 such that the system 20 may use the updated information and identify that the parking location 16 is now unoccupied and available.

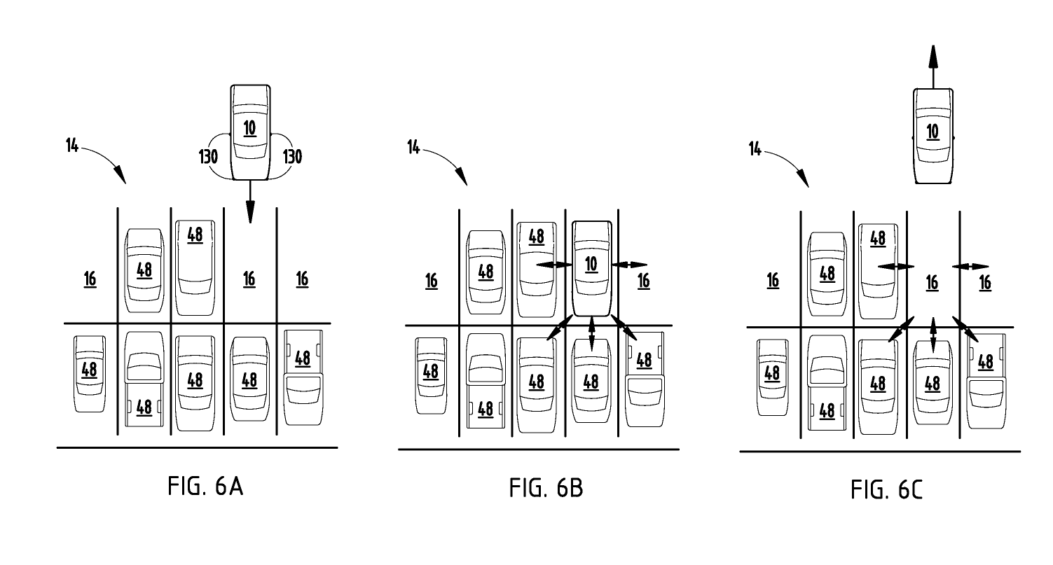

Referring to FIGS. 6A-6C, a parking lot 14 is illustrated with a vehicle 10 approaching an available parking location 16, according to another embodiment. In this embodiment, the vehicle 10 employs various sensors 130 for sensing the area surrounding the vehicle. The sensors 130 may include proximity sensors such as radar sensors and imaging devices, such as cameras. The proximity sensors 130 detect the regions around the vehicle 10 and report information regarding the detected regions to the vehicle parking locator system 20. As shown in FIG. 6B, the vehicle 10 is parked within an available parking location 16 and the proximity sensors 130 detect whether the parking locations to the lateral sides of the vehicle 10, forward of the vehicle 10, and to the front corners of the vehicle 10 are occupied by other vehicles or not. The vehicle 10 may then report the proximity sensed information to the vehicle parking locator system 20 so that it may use that information for determining parking location information. In FIG. 6C, the vehicle 10 departs the available parking location and may report via its GPS determined position that it is no longer parked within the previously occupied parking location.

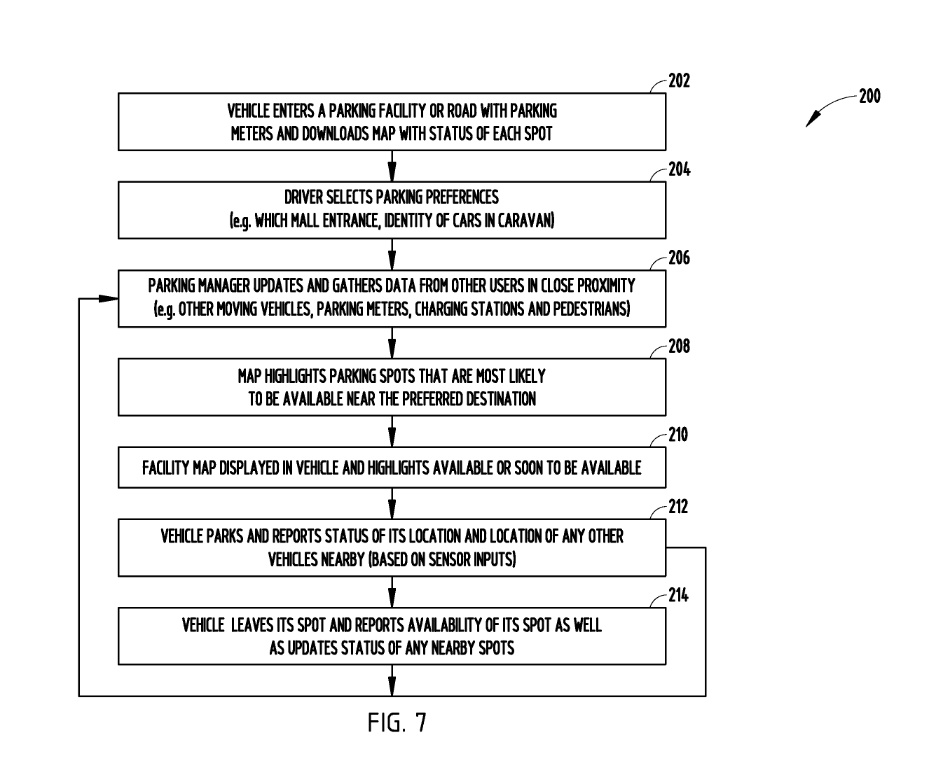

Referring to FIG. 7, a routine 200 is illustrated for acquiring parking location information and reporting parking location information with the parking locator system 20, according to one embodiment. Routine 200 begins at step 202 in which the vehicle enters a parking facility or road with parking meters and downloads a map with the status of each parking location. The map may be downloaded from the vehicle parking locator system 20 to a vehicle 10, according to one embodiment. The vehicle 10 may also acquire parking location information from the vehicle parking locator system 20. Proceeding to step 204, a driver selects parking preferences. For example, a driver may select which entrance of a mall is preferred, or may identify other vehicles traveling together in a caravan, such that all vehicles in the caravan may find suitable nearby parking. Next, in step 206, the parking manager of the vehicle parking locator system updates and gathers parking location information from other connected sources including users in close proximity to the downloaded map. For example, other moving vehicles, parking meters, electronic vehicle charging stations and pedestrians may provide information to the parking locator system that are used to determine the availability of parking locations in the desired area. In step 208, routine 200 proceeds to provide a map for display that highlights the parking spots that are most likely to be available near the preferred destination. The map is then presented for display in the vehicle searching for a parking spot and highlights the available or soon to be available parking locations at step 210. Next, at step 212, when the vehicle parks within a parking location, the vehicle location is reported to the vehicle parking locator system along with other vehicle information such as availability of nearby parking spots as detected by the vehicle proximity sensors. When the vehicle leaves the parking spot, the vehicle then reports the availability of its own parking spot as well as updates the status of nearby parking spots in step 214. Accordingly, the vehicle is used as a connected source to provide vehicle parking information to the vehicle parking locator system 20 and relies upon information provided by the vehicle parking locator system 20 to aid or assist in parking the vehicle.

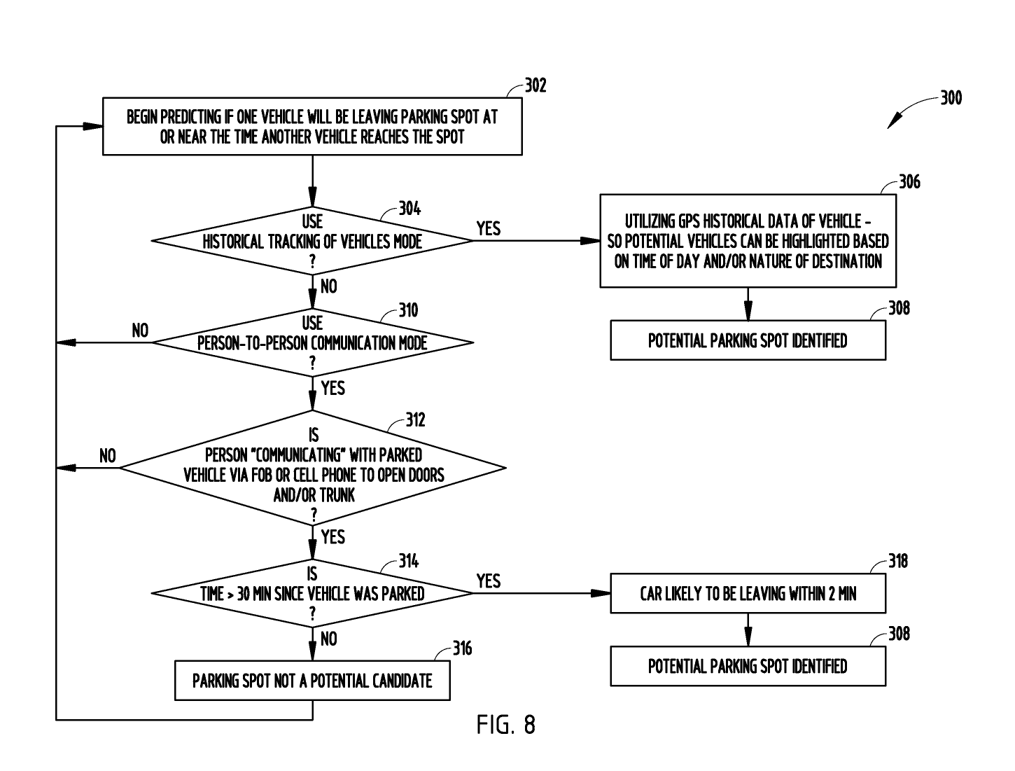

Referring to FIG. 8, a predictive modeling routine 300 is generally illustrated for predicting the availability of future anticipated parking spots with the vehicle parking locator system, according to one embodiment. The routine 300 begins at step 302 to begin predicting if one vehicle will be leaving a parking spot at or near the time another vehicle reaches the same parking spot. Routine 300 decides whether to use a historical tracking of vehicles mode at step 304 which may include using the periodic history of the use of the vehicle such as whether the vehicle arrives at work at a certain time, leaves work at a certain time, and has preferred parking locations such as near a certain door of a facility. If the historical tracking of vehicles mode is used, routine 300 proceeds to step 306 which utilizes GPS and historical data of the vehicle so that potential vehicles can be highlighted based on time of day and/or nature of the destination. Next, at step 308, potential parking locations may be identified based upon the historical data. If routine 300 is not in the historical tracking of vehicles mode, routine 300 proceeds to step 310 to determine whether to use the person-to-vehicle communication mode which may use person-to-vehicle communications, such as key fob signals. If the person-to-vehicle communication mode is used, then routine 300 proceeds to step 312 to determine if a person communicates with a parked vehicle via the key fob or cell phone to open doors and/or trunk, according to one example. If a person communicates via the key fob or cell phone, then routine 300 proceeds to decision step 314, in which routine 300 determines if the time since the vehicle is parked exceeds a time threshold, such as thirty minutes and, if not, the parking spot is determined not to be a potential candidate. If the vehicle has been parked for greater than the time threshold of thirty minutes, and the person-to-vehicle communication has been activated, the vehicle is presumed to be departing the current parking location as set forth in step 318 which the vehicle is likely to be leaving within two minutes and the potential parking spot can thereby be identified. Accordingly, the vehicle parking locator system 20 may advantageously predict when a vehicle is departing from a vehicle parking location based upon a person-to-vehicle communication or historical tracking of the vehicle. It should further be appreciated that further predictions of vehicles arriving at or departing from one or more parking locations may be determined by the vehicle parking locator system 20, according to other embodiments.

Accordingly, the vehicle parking locator system 20 advantageously provides for an enhanced parking location assist for vehicles so as to help manage the vehicle parking scenario. The vehicle parking locator system 20 advantageously utilizes connected vehicles and other data sources to provide for enhanced parking assist particularly in an urban environment.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A vehicle parking locator system comprising:
a database storing data pertaining to vehicle parking locations including available parking locations;
a communication link for communicating with one or more vehicles, said communication link receiving parking location information including information pertaining to the availability of one or more parking locations, said communication link further providing one or more vehicles with parking location information to assist in locating a parking location; and
a processor for processing the stored data in the database and generating parking location information relevant to one or more vehicles.

2. The system as defined in claim 1, wherein the database is located remote from a vehicle.

3. The system as defined in claim 1, wherein the communication link receives parking location information from one or more vehicles.

4. The system as defined in claim 2, wherein the one or more vehicles comprise one or more sensors for sensing availability of one or more parking locations, wherein the vehicle inputs the sensed parking location data to the database.

5. The system as defined in claim 4, wherein the vehicle comprises a location sensor for providing location of the vehicle, wherein the database may determine whether the vehicle is located in a parking location or not.

6. The system as defined in claim 4, wherein the vehicle comprises sensors for detecting vehicles and locations adjacent to the vehicle so as to determine whether or not parking locations are available or not.

7. The system as defined in claim 6, wherein the vehicle sensors detect availability of parking locations as the vehicle is traveling.

8. The system as defined in claim 1, wherein the database further receives inputs from monitored parking locations indicating whether or not one or more vehicles are located at the monitored parking locations.

9. The system as defined in claim 4, wherein the database receives a signal from a communication device that interacts with a vehicle, such that the interaction may be indicative of the vehicle expected to leave a parking location.

10. The system as defined in claim 9, wherein the communication device comprises a vehicle fob, such that activation of the fob is used to predict that the vehicle will soon depart a parking location.

11. The system as defined in claim 1, wherein the database further receives driver preferences so as to select available parking locations based on the driver's preferences.

12. A method for managing vehicle parking locations and providing parking location information to one or more vehicles, said method comprising the steps of:
storing data in a database pertaining to vehicle parking locations including available parking locations;
receiving parking location information input via a communication link including information pertaining to availability of parking locations;
processing the stored data in the database with a processor; and
communicating via the communication link with one or more vehicles to provide the one or more vehicles with parking location information to assist in locating a parking location.

13. The method as defined in claim 12 further comprising the step of receiving park location information from one or more vehicles via the communication link.

14. The method as defined in claim 13, wherein the one or more vehicles comprise sensors for sensing availability of one or more parking locations, wherein the vehicle inputs the sensed parking location data to the database.

15. The method as defined in claim 14 further comprising the step of sensing location of the vehicle and providing the sensed location of the vehicle to the database.

16. The method as defined in claim 14, wherein vehicle sensors detect availability of parking locations as the vehicle is traveling.

17. The method as defined in claim 12 further comprising the step of receiving inputs from monitored parking locations indicating whether or not one or more vehicles are located at the monitored parking locations.

18. The method as defined in claim 12 further comprising the step of receiving a signal from a communication device that interacts with a vehicle, such that the interaction may be indicative of the vehicle expected to leave a parking location.

19. The method as defined in claim 18, wherein the received signal comprises a signal from a vehicle fob.

20. The method as defined in claim 12 further comprising the step of processing driver preferences so as to select available parking locations based on the driver's preferences.
